(19) United States
(12) Patent Application Publication
(10) Pub. No.: US 2023/0271319 A1
(43) Pub. Date: Aug. 31, 2023

(54) METHOD OF GENERATING A LEARNING MODEL FOR TRANSFERRING FLUID FROM ONE CONTAINER TO ANOTHER BY CONTROLLING ROBOT ARM BASED ON A MACHINE-LEARNED LEARNING MODEL, AND A METHOD AND SYSTEM FOR WEIGHING THE FLUID

(71) Applicants: DENSO WAVE INCORPORATED, Chita-gun (JP); INTEGRAL AI INC., Mountain View, CA (US)

(72) Inventors: Yosuke YAMAMOTO, Chita-gun (JP); Jad TARIFI, Mountain View, CA (US)

(73) Assignees: DENSO WAVE INCORPORATED, Chita-gun (JP); INTEGRAL AI INC., Mountain View, CA (US)

(21) Appl. No.: 17/682,339

(22) Filed: Feb. 28, 2022

(51) Int. Cl. B25J 9/16

(52) U.S. Cl. CPC B25J 9/163; B25J 9/1635; B25J 9/1679

(57) ABSTRACT

A system for controlling a robot arm, a fluid contained in a container is poured into another container. A learning model is generated by a machine learning with teaching data. Practically, a plurality of sets of learning data are acquired, each set including i) time-series information showing a posture of a robot arm which holds a first container holding therein a target fluid and pouring the target fluid from the first container to a second container and ii) a weight of the second container which changes time serially. This learning model is used such that only two types of information consisting of the information showing the posture of the robot arm and the weight of the second container at a first time are inputted to the learning model and information showing the posture of the robot arm at a second time is outputted from the learning model.

### BACKGROUND

### Technical Field

The present disclosure relates to a method of generating a learning model for transferring fluid from one container to another by controlling a robotic arm, and a method and system for weighing fluid. In particular, the present disclosure relates to a method for generating a learning model for controlling a robot arm based on a machine-learned learning model to transfer a fluid in one container to another container, and a method and system for weighing the fluid.

### Related Art

In recent years, there has been development of technology that allows robots to perform tasks that were previously performed by humans. One such technology uses a robot arm and machine learning to automatically perform the weighing process, for example, transferring a specified amount of liquid from one container to another. However, in the conventional configuration, there is still room for improvement in terms of machine learning methods.

### CITATION LIST

### Patent Literature

[PTL 1] JP 2021-164980

### SUMMARY

The purpose of the present disclosure is to make further improvements in terms of configuration and processing with respect to machine learning methods in a method that incorporates machine learning in the control of weighing fluids, including liquids, with a robot arm.

According to an exemplary embodiment of the present disclosure, there is provided a method of generating a learning model for machine learning, comprising: acquiring a plurality of learning data (teaching data) including i) time-series information showing a posture of a robot arm, the robot arm holding a first container containing therein a targeted fluid and pouring the fluid from the first container to a second container, and ii) a weight of the second container which changes time serially; and generating a learning model based on the learning data, the learning model being given, as input thereto, only two types of information consisting of the information showing the posture of the robot arm at a first time and the weight of the weight of the second container and outputting the information showing the posture of the robot arm at a second time.

According to another aspect, there is also provided a system and a method, in which a robot arm is controlled by using AI (artificial intelligence) to transfer the fluid in a container into another container using the teacher data (learning data) generated as described above.

Therefore, the robot arm can be controlled based on the learning model generated based on the teacher data (learning data) to automate the process of transferring the target fluid from the first container to the second container. Therefore, the various benefits of such automation can be enjoyed.

In addition, the learning model is generated using only two types of input information: the time-series information about the robot arm's posture and the time-series weight of the second container. This differs from previously known methods in that it does not require an image of the first container. This simplifies the system configuration by eliminating the need for image information from the optical imaging system, and enables weighing with the same or higher accuracy and in a shorter time than conventional known methods.

Other configurations and effects other than those described above will become clear in the examples described below with the drawings.

### BRIEF DESCRIPTIONS OF THE DRAWINGS

In the accompanying drawings:

FIG. 1 is a diagram conceptually showing an example of the configuration of a weighing system

FIG. 2 is a diagram conceptually showing an example of the configuration of a robot arm according to the embodiment.

FIG. 3 is a functional block diagram conceptually showing an example of the configuration of a weighing system according to the embodiment.

FIG. 4 a block diagram conceptually illustrating an example of the hardware configuration of an information processing device according to the embodiment.

FIG. 5 shows illustrations conceptually showing an example of learning data in the embodiment.

FIG. 6 is a flowchart showing an example of control contents for generating learning data in the embodiment.

FIG. 7 is an illustration conceptually exemplifying an example of a learning model used in the embodiment.

FIG. 8 is a flowchart exemplifying control contents for executing the weighing process performed in the embodiment.

### DESCRIPTION OF PREFERRED EMBODIMENT

One embodiment is described below with reference to the drawings. A weighing system 1 is a system capable of performing the weighing process of pouring and transferring a specified amount of fluid from a first container 91 to a second container 92 by controlling a robot arm 10 based on machine learning. Note that the above machine learning employs, in particular, a learning method classified as supervised learning.

The weighing system 1 machine-learns the relationship between the movement of the robot arm 10 when pouring the contents of the first container 91 and the weight of the second container 92, i.e., the weight of the fluid poured into the second container 92, which is changed by the movement of the robot arm 10. Using the learning model obtained by the machine learning, the robot arm 10 is automatically operated to achieve the target weighing value specified by the user, for example.

The robot arm 10 is configured to hold the first container 91, for example by grasping it. The robot arm then transfers the held first container 91 to the vicinity of the second container 92 and tilts the first container 91 with respect to the second container 92 to pour and transfer the fluid contained in the first container 91 into the second container 92. In this way, the weighing system 1 weighs a predetermined amount of fluid contained in the first container 91.

The shape, size, color, and weight of the first and second containers 91 and 92 are not limited to any particular configuration herein. The fluid to be weighed by the weighing system 1 is not limited to liquids, but can also be powders or granules that have flowable properties. When a liquid is the object of weighing, the color and viscosity of the liquid are not limited. The amount of fluid contained in the first and second containers 91 and 92 at the time of weighing is also not particularly limited. In this specification, when referring to the weight of the first or second container 91 or 92, it shall also include the weight of the fluid contained in the first or second container 91 or 92.

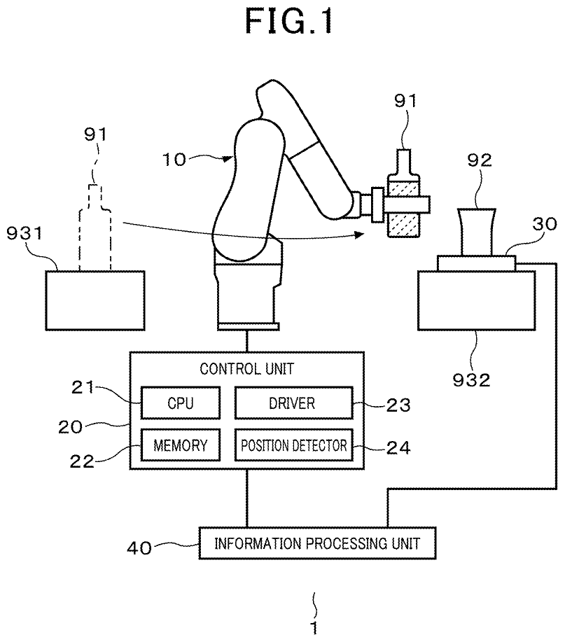

The weighing system 1 is equipped with a robot arm 10, a control unit 20, a weighing instrument 30, and an information processing unit 40, as shown in FIG. 1. The weighing system 1 does not use image or video information for control and machine learning of the robot arm (manipulator) 10. Therefore, the weighing system 1 can be configured without including optical equipment such as cameras. The robot arm 10 should be able to hold and tilt the first container 91 to pour the fluid contained in the first container 91 into the second container 92. The robot arm 10 may be, for example, a horizontal articulated robot, a parallel link side robot arm, or an orthogonal robot arm.

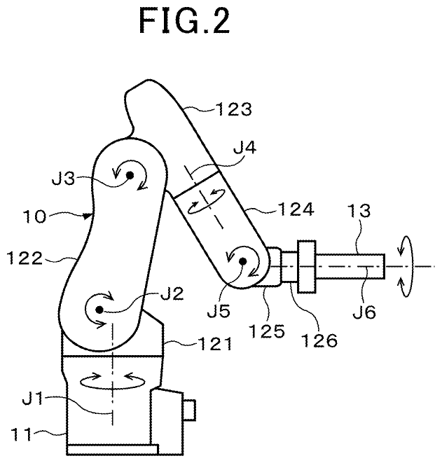

The robot arm 10 can be composed of a vertically articulated robot with six axes (joints), for example, as shown in FIG. 2. The robot arm 10 has a base 11 and a plurality of arms 121-126 (in this example, 6 arms). Each arm (arm portion) 121-126 is provided in turn on the base 11. In this case, they are referred to as a first arm 121, a second arm 122, a third arm 123, a fourth arm 124, a fifth arm 125, and a sixth arm 126, in order from the base 11 side.

The arms 121-126 are connected to each other via a plurality of axes J1-J6, respectively, to allow rotation around said axes. In this case, the axes are referred to as a first axis J1, a second axis J2, a third axis J3, a fourth axis J4, a fifth axis J5, and a sixth axis J6, in the order from the base 11 side. If each axis J1(−J6) is not specified, the respective axes J1-J6 are collectively referred to simply as an axis J. Each of the axes J1-J6 can be individually driven by a servo motor, for example. In this embodiment, information about (or showing) the posture of the robot arm 10 means the state of the robot arm 10, which is composed of a set of rotation angles θn of the respective axes Jn. In this case, “n” means a positive integer corresponding to each of the axes J1-J6. For example, when the angle θ1 is used, it means the angle of the first axis J1. The n-th axis rotation angle θn is sometimes referred to herein as the n-th axis angle θn.

Here, when pouring the fluid in the first container 91 into another container, if one tries to tilt the first container 91 by rotating only the sixth axis J6, the position of the spout of the first container 91, i.e., the part from which the fluid flows out of the first container 91, will move in the vertical and horizontal directions. Therefore, when a person weighs, he or she usually tilts the container by lifting the bottom part of the container using the area around the container spout as a fulcrum. Hence, in this embodiment, the axis Jn used for information on the posture of the robot arm 10 includes not only the axis affecting the rotation angle of the first container 91, in this case, the sixth axis J6, but also all axes affecting the position of the spout of the first container 91, that is, the position of the fluid outflow. This allows the weighing system 1 to learn and model on human behavior more accurately.

The sixth arm 126 serves as an end portion of the robot arm 10 and is configured, for example, in the shape of a flange. A tool section 13 is removably attached to the tip of the sixth arm 126. The tool section 13 is referred to as a chuck or gripper, for example. In this case, the tool section 13 can hold the first container 91. The robot arm 10 has servo motors for driving each axis J1(−J6), encoders for detecting the rotation speed and position of each of the axes J1-J6, and brakes for stopping the motion of each of the axes J1-J6, although details are not shown.

The control unit 20 is a so-called robot controller and has the function of controlling the operation of the robot arm (manipulator) 10. The robot arm 10 and the control unit 20 are configured to communicate with each other by wired or wireless means. The control unit 20 may be wired or wirelessly intercommunicatable to other external devices, such as a personal computer or a portable terminal such as a smart phone. The control unit 20 may be built into the robot arm 10, or it may be realized by a server or other device to control the robot arm 10 remotely. The control unit 20 may be configured with the same or common hardware as the information processing unit 40.

The control unit 20 can be composed of, for example, the CPU 21, a memory 22, a driver 23, and a position detection unit 24, as shown in FIG. 1. The memory 22 comprises a storage area, such as ROM, RAM, and rewritable flash memory, and stores a computer program that controls the operation of the robot arm 10. Thus, the storage section functions as a non-transitory computer recording medium. The driver 23 is composed of an inverter circuit, for example, and can control the motion of each of the axes (joints) J1-J6 of the robot arm 10 by controlling the current to the motor of each of the axes (joints) J1-J6. The control unit 20 controls the movement of the robot arm 10 based on information about the posture of the robot arm received from the information processing unit 40.

The position detection unit 24 is composed of, for example, an encoder or the like provided for each axis (joint) J1-J6, and can detect the rotation angle θn of each axis J1-J6, i.e., the rotation angle of each motor. The control unit 20 drives the respective motors by feedback control, for example, based on the position of each axis J1-J6 detected by the position detection unit 24. The control unit 20 transmits the position of each axis J1-J6, i.e., the rotation angle of each motor, detected by the position detection unit 24 to the information processing unit 40, along with the acquired time.

The weighing instrument 30 can be composed of, for example, an electronic scale. The second container 92 is placed on the weighing instrument 30. The weighing instrument 30 measures the weight of the second container 92 at predetermined intervals and transmits the measurement results, along with the time of acquisition, to the information processing unit 40.

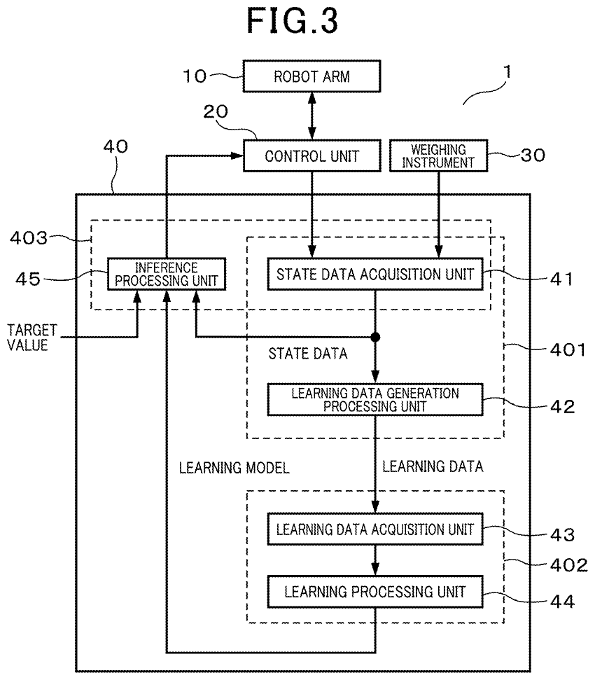

As shown in FIG. 3, the information processing unit comprises a learning data generator 401, a learning model generator 402, and an inference device 403. The learning data generator 401, the learning model generator 402, and the inference device 403 can be composed of functional parts that are virtually realized by executing computer programs on a CPU, for example. The learning data generator 401, the learning model generator 402, and the inference device 403 can be configured with the same or common hardware or with different hardware.

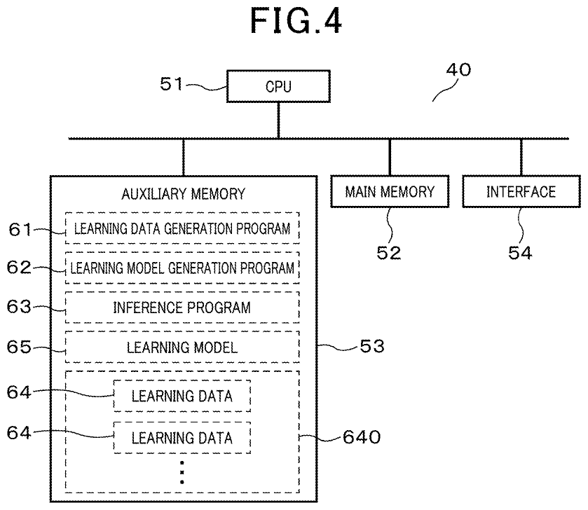

The hardware configuration of the information processing unit 40 can comprise a CPU 51, a main memory 52, an auxiliary memory 53, and an interface 54, as shown in FIG. 4. The auxiliary memory 53 stores each of the computer programs 61, 62, and 63 for virtually realizing the learning data generator 401, the learning model generator 402, and the inference device 403 on a computer. The information processing unit 40 can virtually realize the learning data generator 401, the learning model generator 402, and the inference device 403 on a computer by the CPU 51 reading each of the programs 61, 62, and 63 from auxiliary memory 53, decompressing the programs into the main memory 52, and executing the programs

The CPU 51 stores a plurality of learning data 64 for machine learning generated by the learning data generator 401 and a learning model 65 generated by the learning model generator 402 in the main memory 52 or the auxiliary memory 53 according to the program. In this embodiment, the CPU 51 can store the plurality of learning data 64 in the main memory 52 or the auxiliary memory 53 as learning data group 640, even though they are compiled for use by the computer. The learning data 64 included in the learning data group 640 shown in FIG. 4 have different specific contents, but are marked with the same code for convenience.

The auxiliary memory 53 includes a tangible, non-transitory computer reading recoding medium. Examples of auxiliary memory 53 include HDD (Hard Disk Drive), SSD (Solid State Drive), magnetic disks, optical disks, CD-ROM (Compact Disc Read Only Memory), DVD-ROM (Digital Versatile Disc Read Only Memory), and semiconductor memory. The auxiliary memory 53 may be internal media directly connected to the bus of the computer comprising the information processing unit 40, or it may be external media connected to the information processing unit 40 via the interface 54 or a communication line. When each of the programs 61, 62, and 63 is delivered to information processing unit 40 via a communication line, the information processing unit 40 that receives the delivery decompresses and executes the program in its main memory 52 to realize the above devices 401, 402, and 403.

The realization of each of the devices 401, 402, 403 is not limited to the combination of hardware and program described above, but may be realized by hardware alone, such as integrated circuits with programs implemented in the devices 401, 402, 403, or some functions may be realized by dedicated hardware and some by a combination of information processing unit 40 and programs.

The learning data generator 401 has the function of generating learning data (teacher data) for use in the learning model generator 402. The learning data generator 401 has a state data acquisition unit (first and second state data acquisition unit) 41 and a learning data generation processing unit 42. The state data acquisition unit 41 is capable of executing the state data acquisition process. The state data acquisition process includes a process that functions to acquire state data of the robot arm 10 and the second container 92 when the sample operation of the weighing process is executed by the robot arm 10 as learning data, or teacher data.

Therefore, the weighing system 1 and the weighing method performed therein are implemented in a state where the robot arm is controlled to perform the task of transferring the target fluid from one container to another. In particular, a weighing system and weighing method based on AI (artificial intelligence) technology using a learning model generated by machine learning, called supervised learning, are provided.

The state data acquisition unit 41 successively acquires the state data of the robot arm 10 and the second container 92 at the current time from the control unit 20 and the weighing instrument 30 while the robot arm 10 is being made to perform the sampling operation. The sample operation includes a series of movements of the robot arm 10 in which the robot arm tilts the first container 91 to pour a predetermined amount of fluid into the second container 92, and then returns the tilt of the first container 91 to the previous stage. The sample operation may include the operation from the point at which the robot arm 10 starts grasping the first container 91.

The state data of robot arm 10 to be acquired from the control unit 20 includes the angle θn(t) of each axis J1 to J6 of robot arm 10 at the current time (t) and the current value In(t) of the motor of each of the axes J1 to J6 at the current time (t). In this embodiment, “n” in the current value In means a positive integer corresponding to each of the axes J1-J6, as in the case of angle θn. For example, if the current value I1 is used, it means the current value of the motor corresponding to the first axis 31.

In this specification, the current value In of the motor of the nth axis is sometimes referred to as the nth axis current value In. Since the current value In of each of the axes J1-J6 varies with the load acting on the motor of each of the axes J1-J6, it can be treated as information about the load acting on each of the axes J1-J6, i.e., the load amount. When the robot arm 10 holds the first container 91, the load acting on each of the axes J1-J6 varies according to the weight of the first container 91, so that the current value In of each of the axes J1-J6 can be treated as information about the weight of the first container 91.

The learning data generation processing unit 42 is capable of performing learning data generation processing. The learning data generation process generates learning data from the state data acquired by the state data acquisition unit 41. The learning data generation process generates learning data by mapping the state data of the robot arm 10, i.e., the angle θn(t) of each of the axes J1-J6 at each time and the current In(t) of the motor of each of the axes J1-J6 at each time, and the weight w(t) of the second container 92 at each time at the time of acquisition.

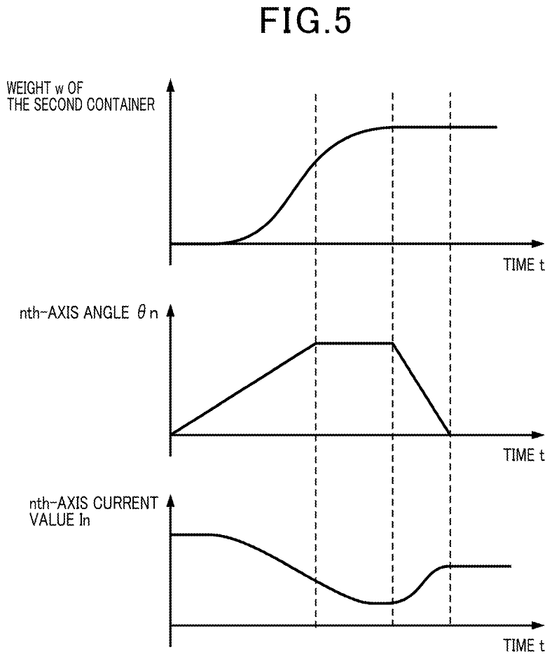

That is, the data for learning is, for example, the time-series data of the angle θn(t) of each of the axes J1-J6, the current value In(t) of the motor of each of the axes J1-J6, and the weight w(t) of the second container 92, as an example shown in FIG. 5. The learning data must include at least the angle θn(t) of each of the axes J1-J6 and the weight w(t) of the second container 92, but including the current In(t) of the motor of each axis J1(−J6) is expected to improve the speed and accuracy of the learning model. In this case, the learning data consists only of information that can be obtained directly from the control unit 20 and the weighing instrument 30 of the robot arm 10, and does not include information obtained using devices other than the control unit 20 and the weighing instrument 30. The learning data generator 401 passes the generated learning data to the learning model generator 402 or stores it in the auxiliary memory 53 shown in FIG. 4.

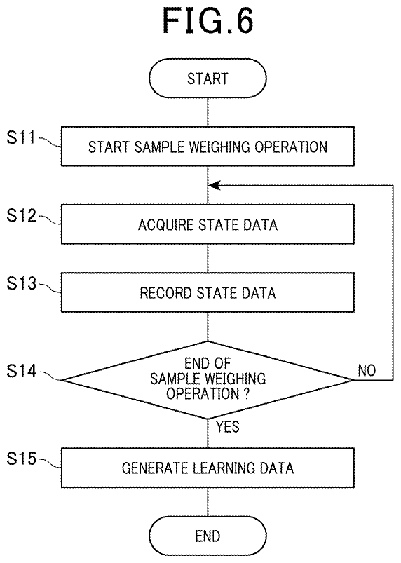

The learning data generator 401, for example, generates learning data based on one sample operation by executing a series of processes shown in FIG. 6. Then, the learning data generator 401, for example, executes the process shown in FIG. 6 multiple times under different conditions for the sample operation, thereby generating learning data based on multiple sample operations under different conditions. In this case, the conditions for the sample operation to be changed include the shape and weight of the first and second containers 91 and 92, the initial amount of fluid previously contained in the first and second containers 92, the target value for weighing, the type of fluid, and the movement speed and trajectory of the robot arm 10.

In step S11, the learning data generator 401 first starts the execution of the sample weighing operation by operating the robot arm 10 via the control unit 20. Next, the learning data generator 401 acquires the current state data of the robot arm 10 and the weighing instrument 30 by the function of the state data acquisition unit 41 in step S12. Then, the learning data generator 401 stores the acquired state data in the main memory 52 or auxiliary memory 53 with the acquisition time in step S13 to accumulate them chronologically.

Next, in step S14, the learning data generator 401 determines whether the sample operation has been completed. If the sample operation has not been completed (NO in step S14), the learning data generator 401 repeats steps S12-S14 until the sample operation is completed. The learning data generator 401 can determine that the sample operation has ended, for example, when a predetermined period of time has elapsed since the robot arm 10 stopped or when an input operation indicating the end is received from the operator. When the sample operation is completed (YES in step S14), the learning data generator 401 moves the process to step S15, where the learning data is generated by the function of the learning data generation processing unit 42. The learning data generator 401 then terminates the series of processes (i.e., the processes are ended).

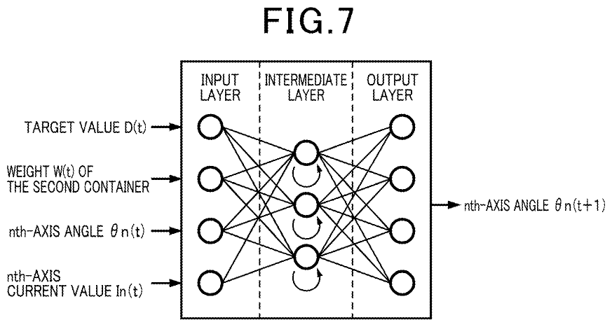

The learning model generator 402 has the function of generating the learning model 65 illustrated in FIG. 7, for example, by machine learning using the plurality of learning data 64. The learning model 65 is a neural network that takes as input information about the posture of the robot arm 10 at the first time (t), i.e., the rotation angle θn of each axis J1(−J6) and the weight w(t) of the second container 92, and outputs information about the posture of the robot arm 10 at the second time (t+1).

In this embodiment, as shown in FIG. 7, the learning model 65 uses as inputs target the value D of the weighing and the weight w(t) of the second container at the first time (t), the rotation angle θn(t) of each axis J1(−J6) of the robot arm 10, as well as the current value I(t) of the motor of each axis J1(−J6).

The learning model 65 has as its output the rotation angle θn(t+1) of each axis J1(−J6) of the robot arm 10 at the second time (t+1). The second time (t+1) is a time later than the first time (t), and the interval between the first time (t) and the second time (t+1) can be set arbitrarily in consideration of data volume and accuracy.

The learning model 65 can use a neural network capable of processing time-series data, such as an RNN (Recurrent Neural Network), MTRNN (Multi Timescale RNN), LSTM (Long Short Term Memory), ARIMA (Auto Regressive Integrated Moving Average), or one-dimensional CNN (Convolutional Neural Network), for example.

The learning model generator 402 has a learning data acquisition unit 43 and a learning processing unit 44, as shown in FIG. 3. The learning data acquisition unit 43 can perform the process of acquiring the plurality of 64 learning data from the learning data generator 401 or the auxiliary memory 53. The learning processing unit 44 performs machine learning using the learning data acquired by the learning data acquisition unit 43 to generate the learning model 65 illustrated in FIG. 7.

When the robot arm 10 holds the first container 91 containing the target fluid and pours the target fluid from the first container 91 into the second container 92, that is, when performing the weighing process, an inference unit 403 has the ability to infer and output information about the posture of the robot arm 10 using the learning model 65. The inference unit 403 has the state data acquisition unit 41 and an inference processing unit 45. In this embodiment, the state data acquisition unit 41 is shared by the learning data generator 401 and the inference unit 403, but it may be configured not to be shared.

The inference processing unit 45 can input the information θn(t) about the posture of the robot arm 10 at the first time (t) and the weight w(t) of the second container 92 to the learning model 65 and output the information θ(t+1) about the posture of the robot arm at the second time (t+1). In this embodiment, in addition to the information θn(t) about the posture of the robot arm 10 at the first time (t) and the weight w (t) of the second container 92, the inference processing inputs to the learning model 65 the information about the force of the robot arm 10, that is, the current In (t) of the motor of each axis J1 to J6. The inference processing unit 45 passes the output information θn(t+1) about the attitude at the second time (t+1) to the control unit 20, as shown in FIG. 3.

In the weighing process, the weighing instrument measures the weight w(t) of the second container 92 at the current time (t) and successively passes the measurement results to the inference unit 403, and the control unit 20 acquires the angles θn(t) of each of the axes J1 to J6 of the robot arm 10 at the current time (t) and successively passes them to the inference unit 403. That is, the inference unit 403 acquires the state data of the robot arm 10 and the second container 92 at the current time (t) from the control unit 20 and the weighing instrument 30. The control unit 20 controls the motion of the robot arm 10 so that the angle θn(t) of each of the axes J1 to J6 of the robot arm 10 at the next time (t+1) output from the inference unit 403.

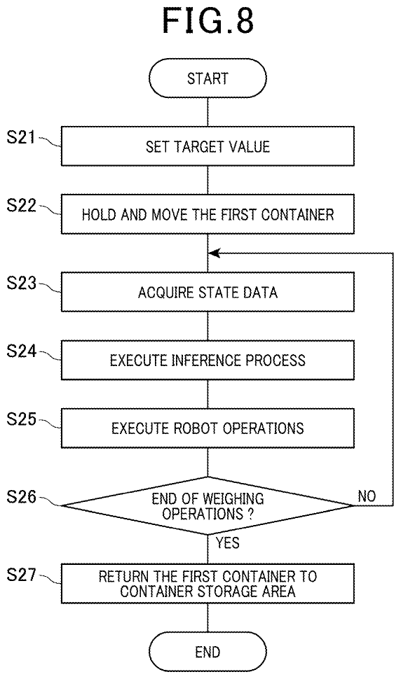

The weighing system 1 can perform the weighing process based on the flow illustrated in FIG. 8. In this embodiment, as shown in FIG. 1, the first and second containers 91 and 92 are placed in container storage areas 931 and 932, respectively. The user inputs the target value D prior to executing the weighing process. The weighing system 1 sets the target value D in step S21 of FIG. 8. Next, the weighing system 1 causes the robot arm 10 to be operated by the control unit 20 to retrieve the first container 91 that is placed on the container storage area 931, and after retrieving the first container 91, the first container 91 is moved to the top of the second container 92.

Next, the weighing system 1 performs the operation of pouring the target amount of fluid into the second container 92 by tilting the first container 91, i.e., weighing, by repeating steps S23 through S26. In step S23, the weighing system 1 obtains the state data of the robot arm 10 and the second container 92 at the current time (t) by the function of the inference unit 403. Next, in step S24, the weighing system 1 calculates information about the posture of the robot arm 10 at the next time (t+1), i.e., each axis angle θn(t+1), by the function of the inference unit 403.

Next, in step S25, the weighing system 1 operates the robot arm 10 so that each axis angle θn(t+1) is calculated in step S24 by the function of the control unit 20. Then, in step S26, the weighing system 1 determines whether the weighing has been completed, and if not (NO in step S26), the process returns to step S23, and if completed (YES in step S26), the process moves to step S27. Whether the weighing has been completed can be judged based on, for example, the fact that the tilt of the first container 91 has returned to the initial state, i.e., the state in step S22, or that no weight change has occurred in the second container 92 for a predetermined period. The weighing system 1 then returns the first container 91 to the original container storage area 931, and so on, thereby completing the series of weighing processes.

According to the embodiment described above, the method of generating the learning model 65 first acquires the learning data 64. The learning data 64 has a plurality of learning data including the time-series information On about the posture of the robot arm 10 when holding the first container 91 containing the target fluid and pouring the target fluid from the first container 91 into the second container 92, and the time-series weight w of the second container 92. Next, using the learning data contained in the learning data 64, a learning model 65 is generated with the information θn(t) about the posture of the robot arm 10 at the first time (t) and the weight w(t) of the second container 92 as inputs thereto and the information θn(t+1) about the posture of the robot arm 10 at the second time (t+1) as output therefrom.

The method of generating learning data of this embodiment includes the process of acquiring time-series information On about the posture of the robot arm when holding the first container 91 containing the target fluid and pouring the target fluid from the first container 91 into the second container 92, the process of acquiring the time-series weight w of the second container 92, and the process of performing the correspondence between the time-series information On about the posture of the robot arm 10 and the time-series weight w of the second container 92.

When the robot arm 10 holds the first container 91 containing the target fluid and pours the target fluid from the first container 91 into the second container 92, The inference method in this embodiment acquires information θn(t) about the posture of the robot arm 10 at the first time (t) and the weight w(t) of the second container 92 at the first time t, and let the information θn(t) about the posture of the robot arm 10 at the first time (t) and the weight w(t) of the second container 92 as inputs. The information θn(t) about the posture of the robot arm 10 at the first time (t) and the weight w(t) of the second container 92 obtained is input to the learning model 65, which is trained using the learning data 64 with the information On(t+1) about the posture of the robot arm 10 at the second time (t+1) as the output and the information θn(t+1) about the posture of the robot arm 10 at the second time (t+1) is output.

The weighing method and weighing system in this embodiment is a method and system in which a robot arm 10 holds a first container 91 containing therein the target fluid and pours the target fluid from the first container 91 into a second container 92. The weighing method and weighing system includes the step (or means) of acquiring information θn(t) about the posture of the robot arm 10 at the first time (t), the step (or means) of acquiring the weight of the second container 92 at the first time (t), the step (or means) of inputting the information θn(t) about the posture of the robot arm and the weight w(t) of the second container 92, the information θn(t+1) about the posture of the robot arm and the weight w(t) of the second container 92 acquired at the fir time (t), the step (means) of outputting (t+1) the information θn(t+1) about the posture of the robot arm 10 at a second time t(+1), and the step (means) of controlling movements of the robot arm 10 based on the information On(t+1) about the posture of the robot arm 10 at the second time (t+1). The learning model 65 is learned using the learning data 64 with the information θn(t) about the posture of the robot arm 10 at the first time (t) and the weight w(t) of the second container 92 as inputs thereto and the information θn(t+1) about the posture of the robot arm at the second time (t+1) as output therefrom.

If the weighing process were to be performed without using machine learning, depending on the viscosity of the fluid contained in the first container 91, the amount of fluid previously contained in the first and second containers 92, and the parameters of the target weighing value, the operation of the robot arm 10 must be changed, and the control program of the robot arm must also be changed. In this case, it is necessary to change the motion of the robot arm 10 based on the difference between the target weighing value and the value of the weighing instrument 30, but it is extremely difficult to prepare a control program for all patterns because the amount of input data and decision items is too large.

In contrast, according to this embodiment, since the robot arm 10 is operated based on the learning model 65 obtained by machine learning, there is no need to prepare numerous control programs to respond to the viscosity of the fluid contained in the first container 91, the amount of fluid previously contained in the first and second containers 91 and 92, and the target weighing value parameters. As a result, the configuration for weighing fluids using the robotic arm can flexibly respond to changes in factors such as the shape of the first container 91 and the type of fluid.

In addition, this embodiment provides the following improvements over previously known weighing methods that use machine learning. First, the inventor has found that, using only two types of information about the posture of the robot arm 10 holding the first container 91 and the weight of the second container 92 as the input data for opportunity learning for weighing, without using three pieces of information, which are the angle of the first container 91, the image or video of the first container 91, and the weight of the second container 92, allows weighing with the same or better accuracy and duration than the conventional configuration which uses the three types of information described above.

Then, since the weighing system 1 and weighing method of this embodiment does not use the image or video, etc. of the first container 91 for machine learning of the motion of the robot arm 10 and control of the motion, it can be a simple configuration that does not include cameras or other optical devices. In other words, no more than three types of information, including images, are needed to generate a learning model. The benefits of reducing the type of information are enormous. Therefore, the weighing system 1 can reduce the data volume to be processed by the information processing unit 40 by not using the image or video, etc. of the first container 91 for controlling the robot arm 10 and machine learning, thereby increasing the speed of the weighing process.

Furthermore, the weighing system 1 and the weighing method use the information On about the posture of the robot arm 10 for machine learning of the movement of the robot arm 10 and control of the movement. According to this method, the weighing process can be performed with high accuracy and at high speed without using the image or video of the first container 91 during the weighing process.

The learning data 64 also contains information about the load acting on the robot arm 10, in this case, the current value In of the motor of each of the axes J1-J6. According to this method, the learning model 65 can include an element of the load acting on each of the axes J1-J6 of the robot arm 10, i.e., the weight of the first container 91. This further improves the accuracy of the learning model 65, and as a result, the weighing process can be executed with even higher accuracy and speed.

The above-described embodiments are not limited to the embodiments described above and in the drawings, but can be modified as appropriate to the extent not to depart from the gist of the invention.

### DESCRIPTION OF PARTIAL REFERENCE LIST

1 . . . weighing system,
10 . . . robot arm
20 . . . control unit
41 . . . state data acquisition unit
42 . . . learning data generation processing unit
43 . . . learning data acquisition unit
44 . . . learning processing unit
45 . . . inference processing unit
64 . . . learning data
65 . . . learning model
91 . . . first container
92 . . . second container
401 . . . learning data generator
402 . . . learning model generator
403 . . . inference device

What is claimed is:

1. A method of generating a learning model for machine learning, comprising:
acquiring a plurality of learning data including i) time-series information showing a posture of a robot arm, the robot arm holding a first container containing therein a targeted fluid and pouring the fluid from the first container to a second container, and ii) a weight of the second container which changes time serially; and
generating a learning model based on the learning data, the learning model being given, as input thereto, only two types of information consisting of the information showing the posture of the robot arm at a first time and the weight of the weight of the second container and outputting the information showing the posture of the robot arm at a second time.

2. The method of generating the learning model according to claim 1, wherein the learning data include information showing a load acting on the robot arm.

3. The method of generating the learning model according to claim 2, wherein the learning data includes current values of motors provided in respective axes of the robot arm, the current values serving as the load acting on the robot arm.

4. A method of generating learning data for machine learning, comprising:
a process of acquiring time-series information showing a posture of a robot arm, the robot arm holding a first container containing therein a targeted fluid and pouring the fluid from the first container to a second container;
a process of acquiring a weight of the second container which changes time serially; and
a process of performing a correspondence mutually only between the two types of information consisting of the time-series information showing the posture of the robot arm and the weight of the second container.

5. A method of inferring a posture of a robot arm, the robot arm holding a first container containing therein a targeted fluid and pouring the fluid from the first container into a second container, the method comprising:
acquiring information showing the posture of the robot arm at a first time;
acquiring a weight of the second container at the first time; and
inputting, to a learning model for machine learning, only the information showing the posture of the robot arm and the weight of the second container acquired at the first time, and making the learning model output information showing the posture of the robot arm at the second time, wherein the learning model has been learned based on learning data which is given as input the information showing the posture of the robot arm and the weight of the second container acquired at the first time and which outputs the information showing the posture of the robot arm at the second time.

6. A method of weighing a target fluid, comprising:
acquiring, at a first time, information showing a posture of a robot arm holding a first container containing therein the target fluid;
acquiring a weight of a second container at the first time;
inputting, to a learning model for machine learning, only two types of information consisting of the information showing the posture of the robot arm and the weight of the second container acquired at the first time, the target fluid is poured from the first container into the second container by the robot arm, and making the learning model output information showing the posture of the robot arm at the second time,
wherein the learning model has been learned based on learning data which is given as input thereto the information showing the posture of the robot arm and the weight of the second container acquired at the first time and which outputs the information showing the posture of the robot arm at the second time; and
controlling movements of the robot arm based on the information showing the posture of the robot arm at the second time.

7. The weighing method of claim 6, wherein the learning data include information showing a load acting on the robot arm.

8. The weighing method of claim 7, wherein the learning data includes current values of motors provided in respective axes of the robot arm, the current values serving as the load acting on the robot arm.

9. A system for weighing a target fluid, comprising:
a first state data acquiring unit acquiring, at a first time, information showing a posture of a robot arm holding a first container containing therein the target fluid;
a second state data acquiring unit acquiring a weight of a second container at the first time;
a learning processing unit inputting, to a learning model for machine learning, the information showing the posture of the robot arm and the weight of the second container acquired at the first time, the target fluid is poured from the first container into the second container by the robot arm, and making the learning model output information showing the posture of the robot arm at the second time,
wherein the learning model has been learned based on learning data which is given as input thereto only two types of information consisting of the information showing the posture of the robot arm and the weight of the second container acquired at the first time and which outputs the information showing the posture of the robot arm at the second time; and
a control unit controlling movements of the robot arm based on the information showing the posture of the robot arm at the second time.
